(19) United States
(12) Patent Application Publication
(10) Pub. No.: US 2025/0217966 A1
(43) Pub. Date: Jul. 3, 2025

(54) IMAGE PROCESSING DEVICE AND IMAGE PROCESSING METHOD

(71) Applicant: Samsung Electronics Co., Ltd., Suwon-si (KR)

(72) Inventors: Young Eun YOO, Suwon-si (KR); Il-Suk PARK, Suwon-si (KR)

(21) Appl. No.: 18/933,026

(22) Filed: Oct. 31, 2024

(30) Foreign Application Priority Data
Dec. 28, 2023 (KR) 10-2023-0194668
Feb. 21, 2024 (KR) 10-2024-0024867

(51) Int. Cl. G06T 7/00; G06T 7/136

(52) U.S. Cl. CPC G06T 7/001; G06T 7/136; G06T 2207/10061; G06T 2207/30148

(57) ABSTRACT

An imaging device and an image processing method are provided. An imaging device according to some embodiments includes a memory and a processor which executes programs stored in the memory. The processor acquires a plurality of first images classified for each pattern of a semiconductor device, by using a SEM (Scanning Electron Microscope) image of the semiconductor device, and acquires a plurality of reference images in which brightness values are adjusted for each pattern of the semiconductor device by using the plurality of first images.

### CROSS-REFERENCE TO RELATED APPLICATIONS

This application claims priority from Korean Patent Application No. 10-2023-0194668 filed on Dec. 28, 2023, and No. 10-2024-0024867 filed on Feb. 21, 2024 in the Korean Intellectual Property Office, and all the benefits accruing therefrom under 35 U.S.C. 119, the contents of which in their entirety are herein incorporated by reference.

### BACKGROUND

### 1. Field

The present disclosure relates to an image processing device and an image processing method.

### 2. Description of the Related Art

As a method for inspecting defects of a semiconductor device, there is an inspecting method using a SEM (Scanning Electron Microscope) apparatus. Defects of the semiconductor device may be detected on the basis of images acquired through the SEM apparatus.

A semiconductor device may include various types of patterns. In this case, it is necessary to further improve the defect detection ability of the semiconductor device by considering the characteristics of each pattern.

### SUMMARY

Aspects of the present disclosure provide an image processing device that may reliably detect defects of each pattern of a semiconductor device.

Aspects of the present disclosure provide an image processing method that may reliably detect defects in each pattern of a semiconductor device.

However, aspects of the present disclosure are not restricted to the one set forth herein. Other aspects of the present disclosure will become more apparent to one of ordinary skill in the art to which the present disclosure pertains by referencing the detailed description of the present disclosure given below.

An image processing device according to some embodiments of the present disclosure for achieving the technical problems includes a memory; and a processor which executes programs stored in the memory, in which the processor acquires a plurality of first images classified for each pattern of a semiconductor device, by using a SEM (Scanning Electron Microscope) image of the semiconductor device, and acquires a plurality of reference images in which brightness values are adjusted for each pattern of the semiconductor device by using the plurality of first images.

An image processing device according to some embodiments of the present disclosure for achieving the aforementioned technical problems include a memory; a processor which executes programs stored in the memory; and an imaging device that acquires SEM (Scanning Electron Microscope) images of the semiconductor device, in which the processor acquires a plurality of first images grouped for each pattern of the semiconductor device, by using the SEM image and a pattern layout of the semiconductor device, acquires a plurality of second images with optimized gray levels for each pattern of the semiconductor device, by using the plurality of first images, and detects defects for each pattern of the semiconductor device on the basis of the plurality of second images.

An image processing method according to some embodiments of the present disclosure for achieving the aforementioned technical problems includes acquiring a plurality of first images classified for each pattern of a semiconductor device, by using a matching image obtained by matching a SEM (Scanning Electron Microscope) image of the semiconductor device with a pattern layout of the semiconductor device; and acquiring a plurality second images in which brightness values are adjusted for each pattern of the semiconductor device, by using the plurality of first images.

Specific details of other embodiments are included in the detailed description and drawings.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram for explaining an image processing device according to aspects of the present disclosure;

FIG. 2 is a diagram for explaining a processor according to aspects of the present disclosure;

FIGS. 3 and 4 are diagrams for explaining an image processing method according to aspects of the present disclosure;

FIG. 5 is a diagram for explaining images acquired by an imaging device according to aspects of the present disclosure;

FIGS. 6 to 8 are diagrams for explaining images obtained by a processor according to a conventional imaging processing method;

FIGS. 9 to 11 are diagrams for explaining images obtained by a processor according to aspects of the imaging processing method of the present disclosure;

FIG. 12 is a diagram for explaining an image processing method according to aspects of the present disclosure, and is a plan view showing an upper face of a wafer; and

FIGS. 13 to 20 are diagrams for explaining and contrasting the effects of a conventional imaging processing method and the image processing method according to aspects of the present disclosure.

### DETAILED DESCRIPTION OF THE EMBODIMENTS

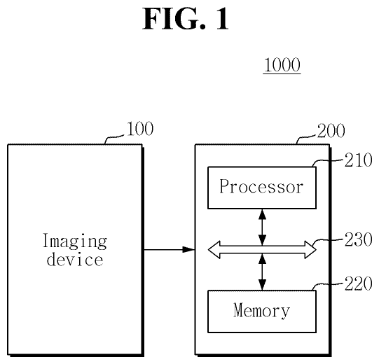

FIG. 1 is a block diagram for explaining an image processing device according to some embodiments.

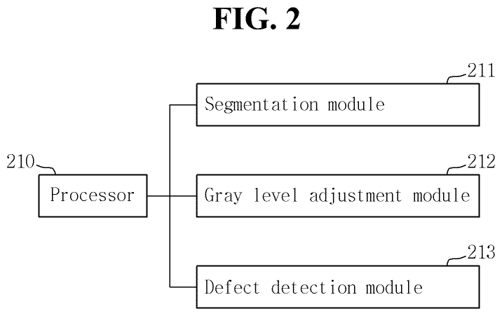

Referring to FIG. 1, an image processing device 1000 according to some embodiments may include an imaging device 100 and a computing system 200. FIG. 2 is a diagram for explaining a processor according to some embodiments.

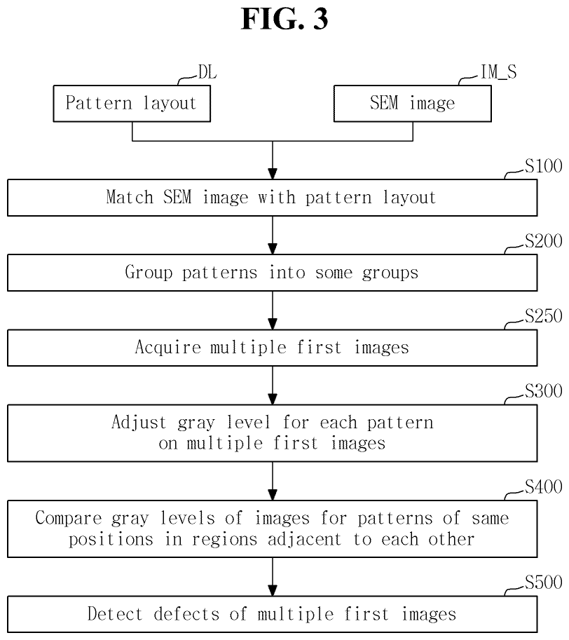

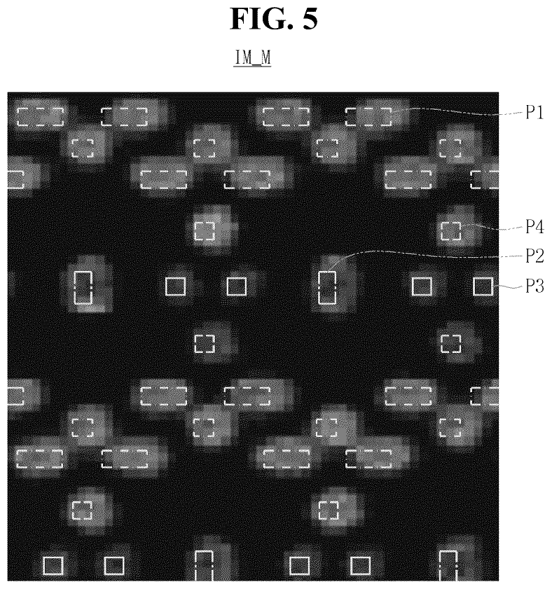

The imaging device 100 may be a device for acquiring an SEM (Scanning Electron Microscope) image (IM_S of FIG. 3) and a matching image (IM_M of FIG. 5), which will be described below. The imaging device 100 may refer to an apparatus that measures a surface of a sample, using secondary electrons generated by interaction with the sample while an electron beam is scanned onto the surface of the sample.

The computing system 200 includes a processor 210 and a memory 220, and the processor 210 and the memory 220 may send and receive data through a bus 230. For example, images measured by the imaging device 100 may be transmitted to the computing system 200 and then stored in the memory 220 of the computing system 200. The data stored in the memory 220 may then undergo various analysis and/or processing processes through analysis software or applications executed on the processor 210.

The processor 210 may control the image processing device 1000. The processor 210 may execute an operating system, firmware, and the like for driving the image processing device 1000.

The processor 210 may include, for example, but not limited to, a core capable of executing arbitrary instructions, such as a microprocessor, an AP (Application Processor), a DSP (Digital Signal Processor), and a GPU (Graphic Processing Unit).

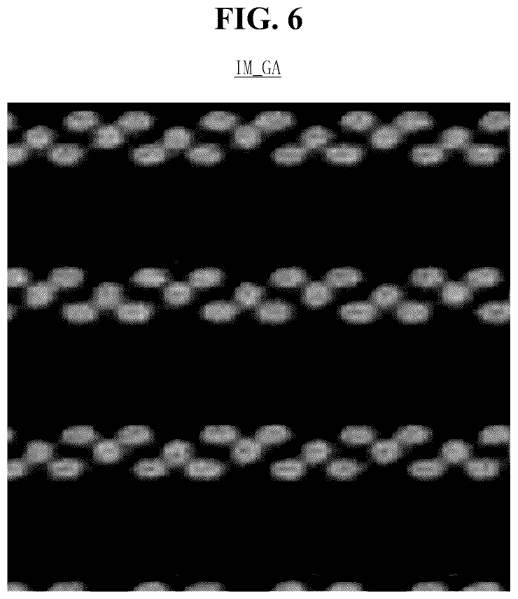

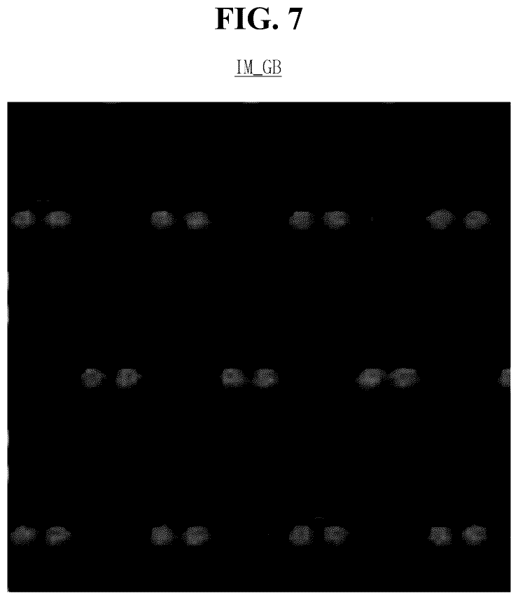

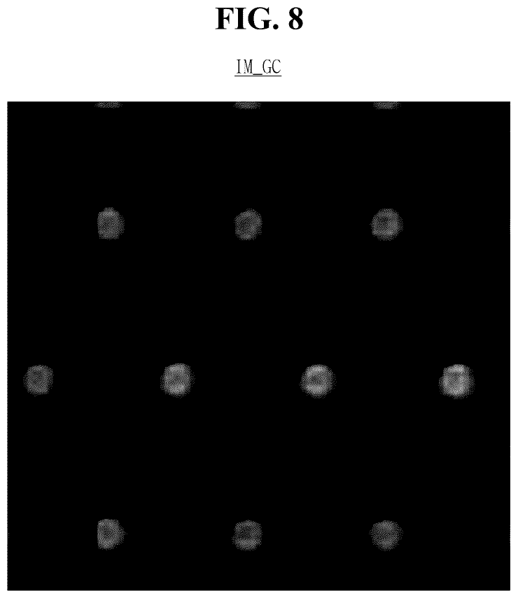

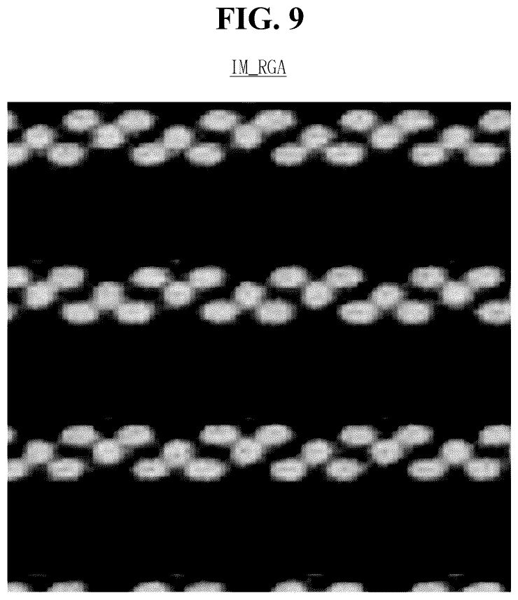

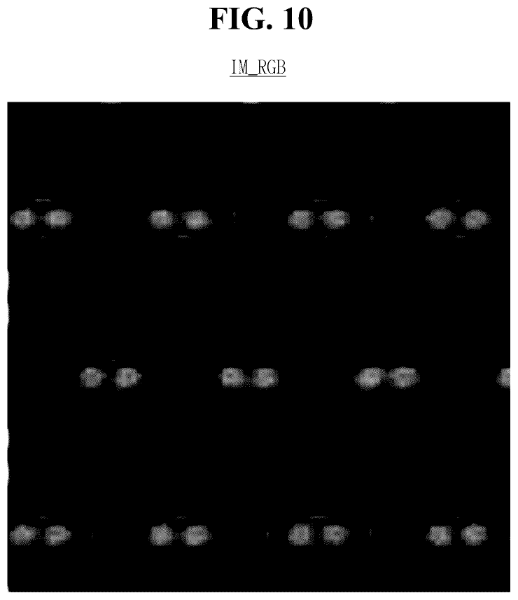

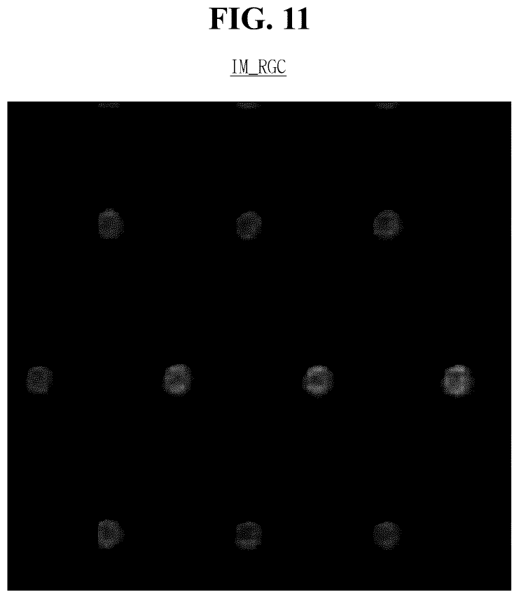

The processor 210 may acquire a plurality of first images (IM_GA to IM_GC of FIGS. 6 to 8), by driving a segmentation module (211 of FIG. 2) loaded into the memory 220 to perform a segmentation task on the SEM image (IM_S of FIG. 3) and the matching image (IM_M of FIG. 5). The processor 210 may acquire a plurality of second images (IM_RGA to IM_RGC of FIGS. 9 to 11), using a gray level adjustment module (212 of FIG. 2) loaded into the memory 220. The processor 210 may detect defects of the semiconductor device, by using a defect detection module (213 of FIG. 2) loaded into the memory 220.

The segmentation module (211 of FIG. 2), the gray level adjustment module (212 of FIG. 2), and the defect detection module (213 of FIG. 2) may be programs or software modules that include a plurality of instructions executed by the processor 210, and may be stored on a computer-readable storage medium.

The memory 220 may store the segmentation module (211 of FIG. 2), the gray level adjustment module 212, and the defect detection module 213. The memory 220 may be, but not limited to, a volatile memory such as a SRAM or a DRAM, or a non-volatile memory such as a PRAM, a MRAM ReRAM, or a FRAM NOR flash memory.

Although not specifically shown, the computing system 200 may further include an input/output device and a storage device.

The input/output device may control user input and output from a user. For example, the input/output device may include an input device such as a keyboard, a mouse, and a touch pad, and may receive input of various data. For example, the input/output device may include an output device such as a display and a speaker, and may display various data.

The storage device may store various data related to the segmentation module (211 of FIG. 2), the gray level adjustment module (212 of FIG. 2), and the defect detection module (213 of FIG. 2). The storage device may store codes, such as an operating system or firmware, executed by the processor 210.

The storage device may include, for example, but not limited to, a memory card (MMC, eMMC, SD, MicroSD, etc.), an SSD (Solid State Drive), and a HDD (Hard Disk Drive).

The processor 210 may include the segmentation module 211, the gray level adjustment module 212, and the defect detection module 213. The specific operation of the processor 210 will be described below.

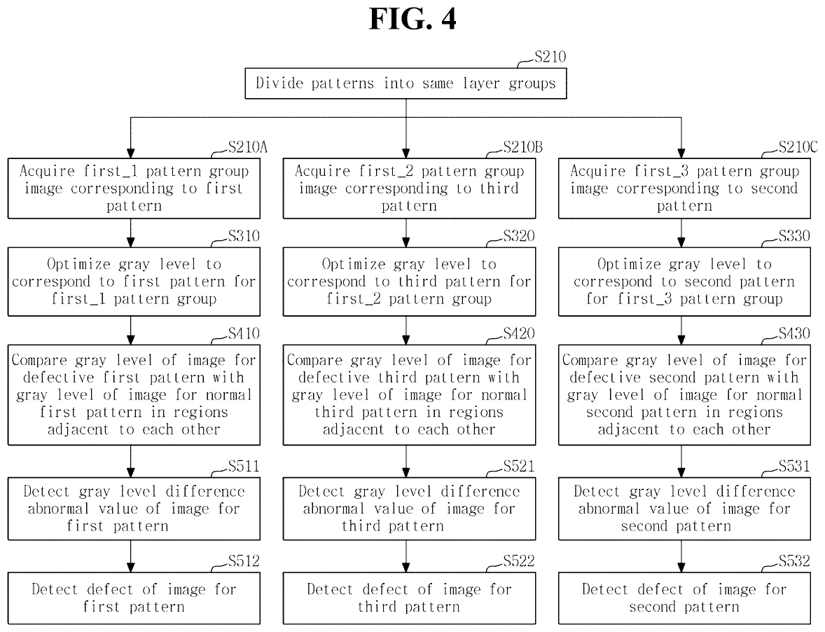

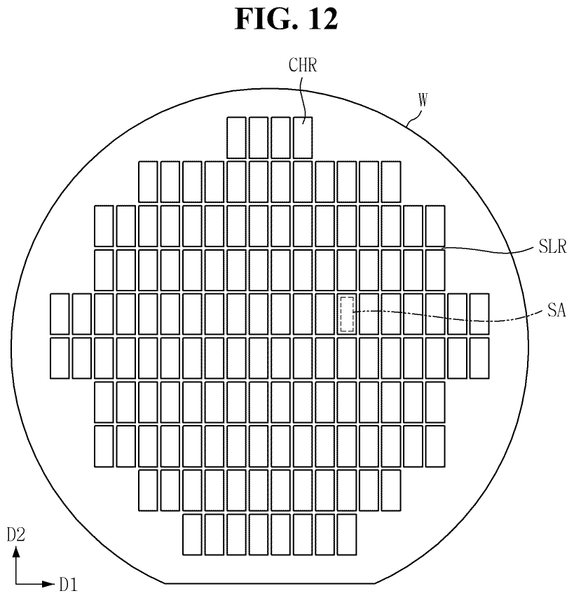

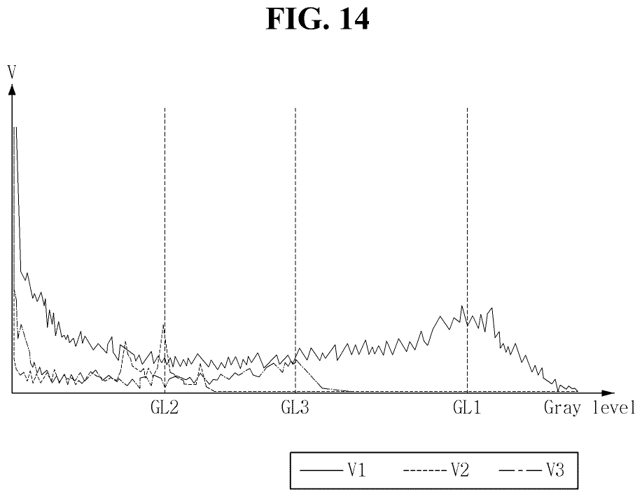

FIGS. 3 and 4 are diagrams for explaining an image processing method according to aspects of the present disclosure. FIG. 5 is a diagram for explaining images acquired by an imaging device according to aspects of the present disclosure. FIGS. 6 to 8 are diagrams for explaining images obtained by the processor according to aspects of the present disclosure. FIGS. 9 to 11 are diagrams for explaining images obtained by the processor according to aspects of the present disclosure. FIG. 12 is a diagram for explaining an image processing method according to aspects of the present disclosure, and is a plan view showing the upper face of a wafer. FIGS. 6 to 8 and FIGS. 9 to 11 are described in further detail below with corresponding FIG. 14.

The imaging device 100 is electrically connected to the processor 210, and may acquire a SEM image IM_S of the semiconductor device. Referring to FIG. 3, the imaging device 100 may match the SEM image IM_S and a pattern design layout (DL) of the semiconductor device to acquire a matching image IM_M (S100). The term “pattern design layout (DL)” may be referred to herein as “pattern layout (DL)” or “pattern layout”.

Referring to FIG. 5, the pattern of the semiconductor device may include first to fourth patterns P1 to P4 that are different from each other. Specifically, the pattern of the semiconductor device may include a first pattern P1 of a PMOS region, a second pattern P2 of an NMOS region, and a third pattern P3 of a gate region. For example, the first pattern P1 may be a via pattern of the PMOS region, the second pattern P2 may be a via pattern of the NMOS region, and the third pattern P3 may be a contact pattern of the gate region, but the present disclosure is not limited thereto.

The segmentation module 211 performs a segmentation task using the SEM image IM_S and the matching image IM_M, and may acquire a plurality of first images IM_G classified for each pattern of the semiconductor device. The segmentation module 211 may group the patterns of the semiconductor devices into separate groups (S200). For example, the segmentation module 211 may divide the patterns of the semiconductor device into separate groups on the basis of the pattern layout DL (S210).

For example, the segmentation module 211 may group the patterns of the semiconductor devices into first to third groups (e.g., patterns P1 to P3) having different electrical characteristics, but the present disclosure is not limited thereto.

The segmentation task according to aspects of the present disclosure may refer to a task of extracting an object of interest from an image pixel by pixel. More specifically, when trying to figure out a position at which the object exists in the image, a shape of that object, which pixels belong to which object, or the like, it may mean dividing the image and assigning labeling to each pixel of the image, but the embodiment is not limited thereto.

The segmentation module 211 may perform a masking process on the matching image IM_M for each pattern of the semiconductor device to acquire a plurality of first images IM_G (S250). For example, the plurality of first images IM_G may include first_1, first_2, and first_3 pattern group images IM_GA, IM_GB, and IM_GC.

Steps S210. S210, S210B, and S210C of FIG. 4 further describe the operation of acquiring the plurality of first images IM_G set forth in step S250. For example, the segmentation module 211 may acquire a first_1 pattern group image IM_GA corresponding to the first pattern P1 (S210A), acquire a first_2 pattern group image IM_GB corresponding to the third pattern P3 (S210B), and acquire a first_3 pattern group image IM_GC corresponding to the second pattern P2 (S210C).

Specifically, the segmentation module 211 may perform a masking process on the regions corresponding to the patterns P2 to P4 except the first pattern P1 of the matching image IM_M to acquire the first_1 pattern group image IM_GA, may perform a masking process on the region corresponding to the patterns P1 to P2 and P4 except the third pattern P3 of the matching image IM_M to acquire the first_2 pattern group image IM_GB, and may perform a masking process on the region corresponding to the patterns P1 and P3 to P4 except the second pattern P2 of the matching image IM_M to acquire the first_3 pattern group image IM_GC.

Accordingly, the segmentation module 211 may perform the grouping task on the matching image IM_M for each pattern.

Referring to FIG. 3, the gray level adjustment module 212 may adjust the gray level on the plurality of first images IM_G for each semiconductor device pattern (S300). Therefore, the gray level adjustment module 212 may acquire reference images IM_RGA, IM_RGB, and IM_RGC with optimized gray levels for each pattern of the semiconductor device.

The gray level adjustment module 212 may acquire a plurality of reference images IM_RGA, IM_RGB, IM_RGC whose brightness values are adjusted for each pattern of the semiconductor device, by using the plurality of first images IM_G.

The plurality of reference images IM_RGA, IM_RGB, and IM_RGC may include a second_1 pattern group image IM_GRA, a second_2 pattern group image IM_RGB, and a second_3 pattern group image IM_RGC.

Referring to FIG. 3, the second_1 pattern group image IM_GRA may be an image whose brightness value is adjusted with respect to the first_1 pattern group image IM_GA. For example, as disclosed in FIG. 4, the gray level adjustment module 212 may optimize the gray level on the first_1 pattern group image IM_GA to correspond to the first pattern P1 to acquire the second_1 pattern group image IM_RGA (S310).

The second_2 pattern group image IM_RGB may be an image whose brightness value is adjusted with respect to the first_2 pattern group image IM_GB. The gray level adjustment module 212 may optimize the gray level of the first_2 pattern group image IM_GB to correspond to the third pattern P3 to acquire the second_2 pattern group image IM_RGB (S320).

The second_3 pattern group image IM_RGC may be an image whose brightness value is adjusted with respect to the first_3 pattern group image IM_GC. The gray level adjustment module 212 may optimize the gray level of the first_3 pattern group image IM_GC to correspond to the second pattern P2 to acquire the second_3 pattern group image IM_RGC (S330).

Accordingly, the brightness values of the plurality of reference images IM_RGA IM_RGB, and IM_RGC of the region corresponding to each pattern of the semiconductor device may be adjusted to be different from each other.

For example, although the brightness of the first_1 pattern group image IM_GA corresponding to the first patterns P1 may be adjusted to be brighter than the brightness of the first_3 pattern group image IM_GC corresponding to the second patterns P2 and the first_2 pattern group image IM_GB corresponding to the third patterns P3, the embodiment is not limited thereto. In this case, the brightness of the image of the first patterns P1 of the PMOS region may be adjusted in the brightest manner, and the brightness of the image of the third patterns P3 of the NMOS region may be adjusted in the darkest manner.

The defect detection module 213 may compare the brightness for each pattern of the semiconductor device at a shot region (SA of FIG. 12) level of the semiconductor device. The defect detection module 213 may compare the gray levels of images for patterns at the same position in a plurality of adjacent shot regions (SA of FIG. 12) (S400).

The shot region (SA of FIG. 12) will be described later.

Referring to FIG. 12, the wafer W may include a plurality of chip regions CHR, and a scribe line region SLR that crosses between the chip regions CHR.

The chip regions CHR may be arranged on the upper face of the wafer W along a first horizontal direction D1 and a second horizontal direction D2 that perpendicularly intersects the first horizontal direction D1. Each chip region CHR may be surrounded by the scribe line region SLR.

Semiconductor memory elements such as a DRAM (Dynamic Random Access Memory), an SRAM (Static Random Access Memory), a NAND flash memory (Flash Memory), and a RRAM (Resistive Random Access Memory) may be provided on the chip region CHR.

In contrast, a processor such as a MEMS (Micro Electro Mechanical Systems) element, an optoelectronic element, a CPU or a DSP may be provided on the chip regions CHR. Alternatively, standard cells including semiconductor elements such as an OR gate or an AND gate may be provided on the chip regions CHR. Redistribution chip pads for inputting/outputting data or signal to the semiconductor integrated circuits and redistribution pads for inputting/outputting signal to the test circuits may be connected to each chip region CHR.

The scribe line region SLR may extend between the chip regions CHR in a first horizontal direction D1 and a second horizontal direction D2. Although not specifically shown, the scribe line region SLR may include a cutting region that is cut by a sawing or dicing machine, and edge regions between the cutting region and the chip regions CHR.

A wafer W may include a plurality of shot regions SA. Each shot region SA may have, but not limited to, a square shape. The shot region SA may be a lithography mask entire region that may be transferred to the wafer W (or photoresist formed on the wafer) through one exposure. A semiconductor device may be formed by overlapping and transferring circuit patterns formed on different masks onto the shot region SA.

Referring to FIG. 3, the defect detection module 213 may compare the gray levels of images for patterns within the same positions in regions adjacent to each other (S400). For example, referring to FIG. 4, the defect detection module 213 may compare the gray level of the reference image IM_RGA for the defective first pattern P1 with the gray level of the reference image IM_RGA for the normal first pattern P1 in the regions adjacent to each other (S410).

Further, the defect detection module 213 may compare the gray level of the reference image IM_RGB for the defective third pattern P3 with the gray level of the reference image IM_RGB for the normal third pattern P3 in the regions adjacent to each other (S420).

In addition, the defect detection module 213 may compare the gray level of the reference image IM_RGC for the defective second pattern P2 with the gray level of the reference image IM_RGC for the normal second pattern P2 in the regions adjacent to each other (S430).

Referring to FIG. 3, the defect detection module 213 may detect defects of the plurality of first images IM_G (S500). Specifically, defects may be detected for each pattern of the semiconductor device on the basis of the plurality of reference images IM_RGA, IM_RGB, and IM_RGC.

The defect detection module 213 may apply a threshold value about the defect for each pattern of the semiconductor device to the plurality of reference images IM_RGA, IM_RGB, and IM_RGC. The threshold value may mean a reference value for discriminating defects of the pattern of the semiconductor device. For example, the threshold value may be set small for a pattern that is the defect detection target, and the threshold value may be set large for other patterns.

For example, the threshold value may be set as 0.7 to the first patterns P1 of the PMOS region, and the threshold value may be set as 0.9 to the second patterns P2 of the gate region, but the present disclosure is not limited thereto.

Accordingly, referring to FIG. 4, the defect detection module 213 may detect a gray level difference abnormal value of the reference image IM_RGA for the first pattern P1 (S511), and may detect the defect of the reference image IM_RGA for the first pattern P1 (S512).

Further, the defect detection module 213 may detect a gray level difference abnormal value of the reference image IM_RGB for the third pattern P3 (S521), and may detect a defect of the reference image IM_RGB for the third pattern P3 (S522).

Further, the defect detection module 213 may detect a gray level difference abnormal value of the reference image IM_RGC for the second pattern P2 (S531), and may detect a defect of the reference image IM_RGC for the second pattern P2 (S532).

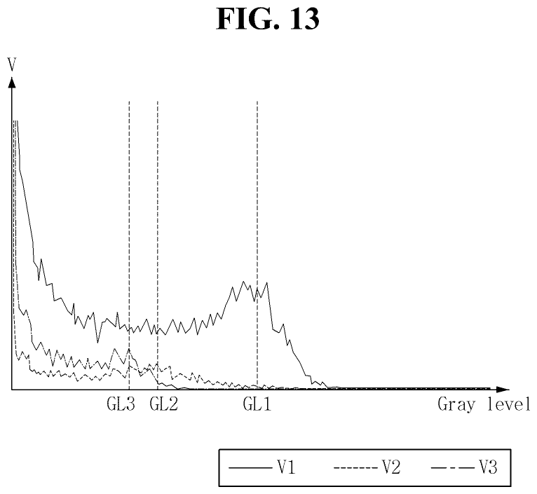

FIGS. 13 to 20 are diagrams for explaining and contrasting the effects of a conventional imaging processing method and the image processing method according to aspects of the present disclosure.

FIG. 13 is a diagram showing a difference in gray level for each pattern according to the conventional image processing method. FIG. 14 is a diagram showing the difference in the gray level for each pattern, as shown in respective FIGS. 6 to 8 and FIGS. 9, 10, and 11, according to the image processing method of the present disclosure. For reference, a vertical axes of FIGS. 13 and 14 may represent a voltage V, and a horizontal axes may represent a gray level value, respectively. In FIGS. 13 and 14, the gray level value increases toward the right, which may mean that the brightness becomes brighter. The aforementioned first to third patterns P1 to P3 may mean patterns having different electrical characteristics. For example, each of the first to third patterns P1, P2, and P3 may each have a different voltage characteristics, such that the voltage characteristic of the first pattern P1 may be voltage V1, the voltage characteristic of the second pattern P2 may be V2, and the voltage characteristic of the third pattern P3 may be V3.

Referring to FIG. 14, it may be understood that a difference between the gray level GL1 of the second_1 pattern group image IM_GRA for the first pattern P1 and the gray level GL2 of the second_3 pattern group image IM_GRC for the second pattern P2 increases compared to FIG. 13. Further, referring to FIG. 14, it may be understood that the difference between the gray level GL3 of the second_2 pattern group image IM_GRB for the third pattern P3 and the gray level GL2 of the second_3 pattern group image IM_GRC for the second pattern P2 increases compared to FIG. 13.

That is, according to the image processing method of the present disclosure, it may be understood that the gray levels between the patterns is distinguished more reliably.

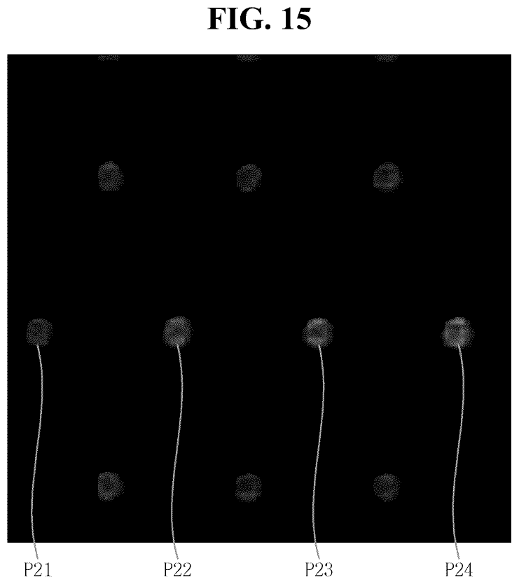

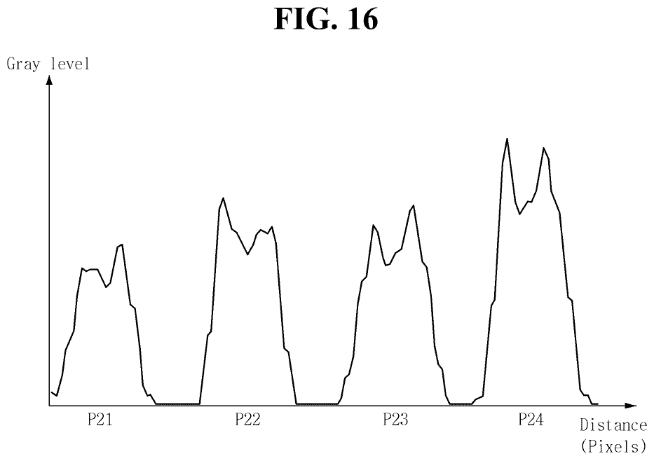

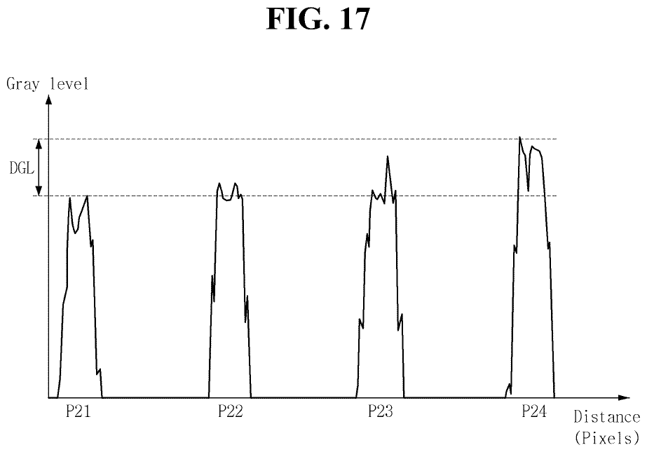

FIG. 16 is a diagram for explaining a gray level profile of one pattern group image according to a conventional image processing method. FIG. 17 is a diagram for explaining a gray level profile of one pattern group image according to aspects of the present disclosure. For reference, FIG. 16 may be a diagram showing gray level profiles according to a conventional image processing method corresponding to positions of four patterns P21 to P24 of a pattern group image of the second pattern P2 shown in FIG. 15. FIG. 17 may be a diagram showing gray level profiles according to aspects of the present disclosure at the positions of four patterns P21 to P24 shown in FIG. 15.

Referring to FIGS. 16 and 17, the dispersion of brightness in one pattern group may be expressed as a difference in gray level (DGL). In FIG. 17, it may be understood that the difference in gray level (DGL) in the images of one pattern group is smaller than the difference in gray level of FIG. 16.

If the dispersion of brightness in one pattern group is large, it means that the noise level is large correspondingly. That is, according to the image processing method of the present disclosure, it may be understood that the dispersion of brightness in the images of one pattern group is improved.

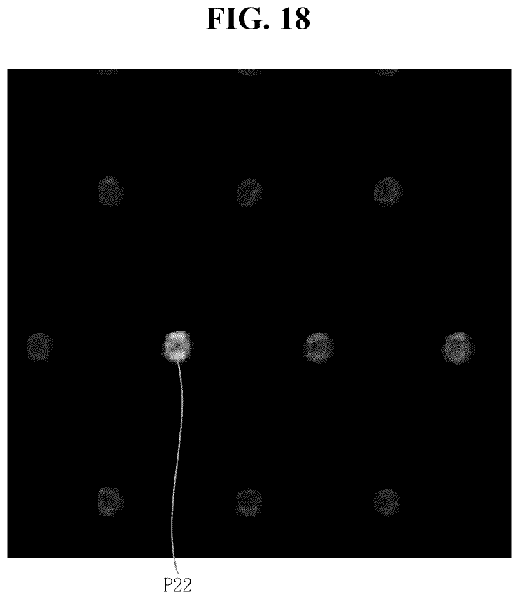

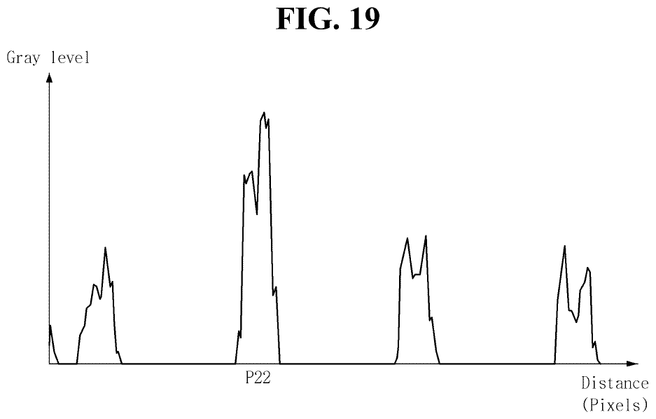

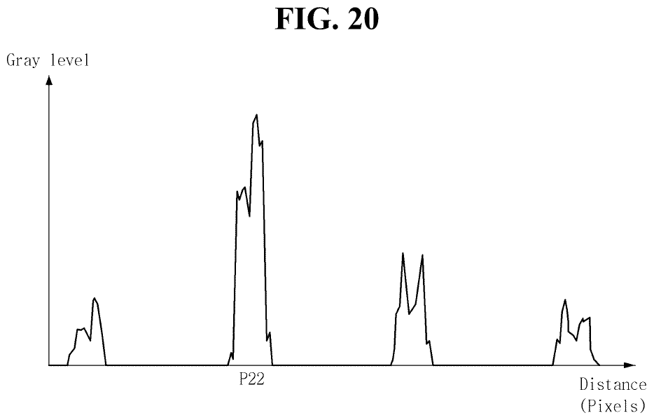

FIG. 19 is a diagram showing a gray level profile of one pattern group image in which a defect is detected according to the conventional image processing method FIG. 20 is a diagram showing a gray level profile of one pattern group image in which a defect is detected according to aspects of the present disclosure. For reference, FIG. 19 may be a diagram showing gray level profiles according to a conventional image processing method corresponding to a position of a defective pattern P22 among the patterns of one pattern group image shown in FIG. 18. FIG. 20 may be a diagram showing gray level profiles according to aspects of the present disclosure at the position of the defective pattern P22 shown in FIG. 18.

Referring to FIGS. 19 and 20, defects in one pattern group are detected on the basis of the gray level difference between the pattern to be detected and surrounding patterns, and therefore the defective signal may be considered to be proportional to the difference in gray level. In FIG. 20, it may be understood that the difference in gray level in the images of one pattern group increases compared to FIG. 19.

That is, according to the image processing method the present disclosure, it may be understood that the defective signal increases in the image of one pattern group in which a defective pattern exists.

In summary, according to the image processing method of the present disclosure, the value corresponding to noise decreases, while the difference between the gray level of the defect pattern and the gray level of the reference image increases, which means that the defect detection signal increases.

In other words, in the related art, if the defect detection signal was so weak that it did not exceed the threshold value and there was a possibility of failure in detecting a defect. However, according to the image processing method of the present disclosure, which undergoes gray level optimization work independently for each pattern, it is understood that this increases the signal to noise ratio (SNR) to improve the reliability of defect detection.

Although the embodiments of the present disclosure have been described above with reference to the accompanying drawings, the present disclosure is not limited to the embodiments, and may be fabricated in various different forms. Those skilled in the art will appreciate that the present disclosure may be embodied in other specific forms without changing the technical spirit or essential features of the present disclosure. Accordingly, the above-described embodiments should be understood in all respects as illustrative and not restrictive.

What is claimed is:

1. An image processing device comprising:
a memory; and
a processor which executes programs stored in the memory,
wherein the processor
acquires a plurality of first images classified for each pattern of a semiconductor device, by using a SEM (Scanning Electron Microscope) image of the semiconductor device, and
acquires a plurality of reference images in which brightness values are adjusted for each pattern of the semiconductor device by using the plurality of first images.

2. The image processing device of claim 1, further comprising:
an imaging device which is electrically connected to the processor, and acquires a SEM image of the semiconductor device,
wherein the imaging device acquires a matching image obtained by matching the SEM image and a pattern layout of the semiconductor device.

3. The image processing device of claim 1,
wherein the pattern of the semiconductor device includes first to third patterns different from each other,
the plurality of first images include a first_1 pattern group image corresponding to the first pattern, a first_2 pattern group image corresponding to the second pattern, and a first_3 pattern group image corresponding to the third pattern, and
the plurality of reference images include a second_1 pattern group image whose brightness value is adjusted with respect to the first_1 pattern group image, a second_2 pattern group image whose brightness value is adjusted with respect to the first_2 pattern group image, and a second_3 pattern group image whose brightness value is adjusted with respect to the first_3 pattern group image.

4. The image processing device of claim 1,
wherein the processor performs masking processing for each pattern of the semiconductor device to acquire the plurality of first images.

5. The image processing device of claim 1,
wherein the processor acquires the plurality of reference images, by optimizing a gray level for each pattern of the semiconductor device with respect to the plurality of first images.

6. The image processing device of claim 1,
wherein brightness values of the plurality of reference images of regions corresponding to each of the patterns of the semiconductor device are different from each other.

7. The image processing device of claim 1,
wherein the processor applies a threshold value corresponding to defects of the pattern of the semiconductor device for each pattern of the semiconductor device.

8. The image processing device of claim 1,
wherein the processor detects defects for each pattern of the semiconductor device on the basis of the plurality of reference images.

9. An image processing device comprising:
a memory;
a processor which executes programs stored in the memory; and
an imaging device that acquires SEM (Scanning Electron Microscope) image of a semiconductor device,
wherein the processor
acquires a plurality of first images grouped for each pattern of the semiconductor device, by using the SEM image and a pattern layout of the semiconductor device,
acquires a plurality of second images with optimized gray levels for each pattern of the semiconductor device, by using the plurality of first images, and
detects defects for each pattern of the semiconductor device on the basis of the plurality of second images.

10. The image processing device of claim 9,
wherein the imaging device acquires a matching image obtained by matching the SEM image with the pattern layout of the semiconductor device.

11. The image processing device of claim 9,
wherein the pattern of the semiconductor device includes first to third patterns of different regions,
the plurality of first images include a first_1 pattern group image corresponding to the first pattern, a first_2 pattern group image corresponding to the second pattern, and a first_3 pattern group image corresponding to the third pattern, and
the plurality of second images include a second_1 pattern group image whose gray level is optimized to correspond to the first pattern, a second_2 pattern group image whose gray level is optimized to correspond to the second pattern, and a second_3 pattern group image whose gray level is optimized to correspond to the third pattern.

12. The image processing device of claim 11,
wherein the processor
performs masking processing on regions corresponding to the second and third patterns to acquire the first_1 pattern group image,
performs masking processing on regions corresponding to the first and third patterns to acquire the first_2 pattern group image, and
performs masking processing on regions corresponding to the first and second patterns to acquire the first_3 pattern group image.

13. The image processing device of claim 11,
wherein the processor
adjusts a brightness value of the first_1 pattern group image to acquire a second_1 pattern group image,
adjusts a brightness value of the first_2 pattern group to acquire a second_2 pattern group image, and
adjusts a brightness value of the first_3 pattern group image to acquire a second_3 pattern group image.

14. The image processing device of claim 13,
wherein the processor adjusts the brightness of the region corresponding to the first pattern of the second_1 pattern group image to be darker than the brightness of the region corresponding to the second pattern of the second_2 pattern group image.

15. An image processing method comprising:
acquiring a plurality of first images classified for each pattern of a semiconductor device, by using a matching image obtained by matching a SEM (Scanning Electron Microscope) image of the semiconductor device with a pattern layout of the semiconductor device; and
acquiring a plurality second images in which brightness values are adjusted for each pattern of the semiconductor device, by using the plurality of first images.

16. The image processing method of claim 15,
wherein the acquiring the plurality of first images comprises:
performing masking processing for each pattern of the semiconductor device.

17. The image processing method of claim 15,
wherein the acquiring the plurality of second images comprises:
optimizing a gray level for each pattern of the semiconductor device on the plurality of first images.

18. The image processing method of claim 15,
wherein brightness of a pattern of a second region of the semiconductor device is adjusted to be darker than brightness of a pattern of a first region of the semiconductor device.

19. The image processing method of claim 15, further comprising:
detecting a defect of the semiconductor device by applying a threshold value for each pattern of the semiconductor device to each of the plurality of second images.

20. The image processing method of claim 19,
wherein the detecting the defect of the semiconductor device comprises:
setting a small threshold value for a pattern that is a defect detection target, and setting a large threshold value for other patterns.
